(19) United States
(12) Patent Application Publication
(10) Pub. No.: US 2012/0113254 A1
(43) Pub. Date: May 10, 2012

(54) MINIATURE BILLBOARD ADVERTISEMENTS HAVING SECURITY FEATURES

(76) Inventor: Arnaldo Zael Cruz, Miami, FL (US)

(21) Appl. No.: 13/289,925

(22) Filed: Nov. 4, 2011

Related U.S. Application Data
(60) Provisional application No. 61/410,804, filed on Nov. 5, 2010.

(51) Int. Cl. H04N 7/18; G09F 15/00

(52) U.S. Cl. 348/143; 40/624; 348/E07.085

(57) ABSTRACT

Street-level advertising billboards may offer advertisers an additional method to reach consumers, either while they are driving or walking through city streets. The billboards may be located on stoplights, walk/don't walk signs, or the like. The billboards may include an electronic display panel for displaying an advertisement, a network interface for wirelessly sending collected data to and receiving advertisement display data from the advertisement system, and a sensor for collecting external data. The billboards may include one or more additional sensors for sensing security threats.

### CROSS-REFERENCE TO RELATED APPLICATIONS

This application claims the benefit of U.S. Provisional application No. 61/410,804, filed Nov. 5, 2010.

### BACKGROUND OF THE INVENTION

The present invention relates to miniature billboards and, more particularly, to miniature billboards, placed at traffic lights, traffic poles and walk/don't walk signs, capable of tracking advertisement reach, recording advertisement demographics, capturing photographs, and providing security scans for weapons, explosives, chemicals and the like.

Advertisements are often placed outdoors in high traffic areas, such along the sides of interstate highways. Modern advertisements may be electronically displayed on large video displays. There are, however, no ways to track the amount of traffic the advertisements may reach. In addition, interstate highway billboards may not be effective at a city street level. City streets typically do not offer areas to post billboards.

Billboards are often used to provide advertisements to consumers and may appear in locations such as airports, train stations or the like. Many of these areas may be higher risk areas for threats, such as terror threats, weapons, explosives, chemicals and the like.

As can be seen, there is a need for miniature billboards that may provide street-level advertisement. There is a further need for a billboard effectiveness monitoring system, allowing advertisers to appreciate the reach of their advertisement. There is a further need for a billboard that may have integrated security features, such as the ability to detect potential terror threats.

### SUMMARY OF THE INVENTION

In one aspect of the present invention, a street-level advertisement system comprises an electronic display panel for displaying an advertisement; a network interface for wirelessly sending collected data to and receiving advertisement display data from the advertisement system; and a sensor for collecting external data.

In another aspect of the present invention, a street-level advertisement system comprises a housing comprising an electronic display panel for displaying an advertisement; a network interface for wirelessly sending collected data to and receiving advertisement display data from the advertisement system; and a memory for storing advertisements; a sensor attached to the housing for collecting external data; and a solar panel array attached to a top portion of the housing for providing power to the advertisement system.

In still another aspect of the present invention, a security device comprises a sensor for continuously scanning an area near the security device for potential security risks; an interface for alerting appropriate personnel of a detected security risk; and an imaging device for capturing an image of a subject of the detected security risk.

These and other features, aspects and advantages of the present invention will become better understood with reference to the following drawings, description and claims.

### BRIEF DESCRIPTION OF THE DRAWINGS

FIG. 1 is a perspective view of a street-level billboard attached to a stop light, according to an embodiment of the present invention;

FIG. 2 is a perspective view of a street-level billboard attached to a walk/don't walk sign, according to an embodiment of the present invention;

FIG. 3 is a perspective view of a street-level billboard attached to stop light wires, according to an embodiment of the present invention;

FIG. 4 is a detail side view of the billboard of FIG. 1;

FIG. 5 is a pictorial view of the billboard deployed on a stop light in a city;

FIG. 6 is a pictorial view of the billboard of FIG. 5 scanning a vehicle as it passes thereunder;

FIG. 7 is a perspective view of the billboard of FIG. 5, showing a scanning device at the lower housing of the billboard;

FIG. 8 is a perspective view of an Exit sign billboard with a scanning device at the lower housing of the billboard; and

FIG. 9 is a perspective view of the billboard of FIG. 4 used in an interior corridor as a security device.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides street-level advertising billboards. The billboards may offer advertisers an additional method to reach consumers, either while they are driving or walking through city streets. The billboards may be located on stoplights, walk/don't walk signs, or the like. The billboards may also contain security features, such as sensors or other scanning means to detect explosives, weapons, chemicals, biological, radioactivity, or the like. The billboards may be placed not only in the streets, but in other locations, such as parking garages, transportation terminals, arenas and the like. The billboards may be adapted to receive and display emergency information in place of advertisements when needed.

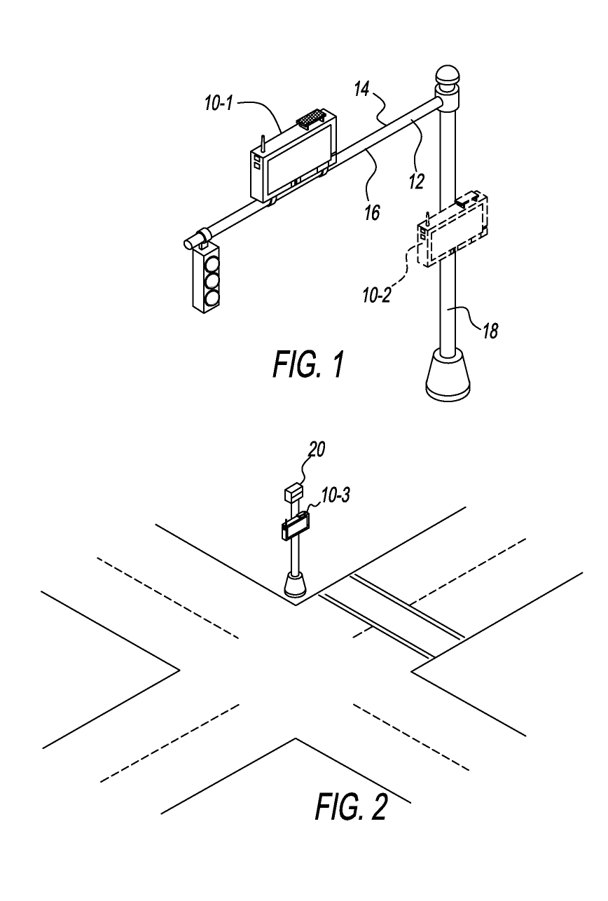

Referring to FIG. 1, there is shown a perspective view of a street-level billboard 10-1 attached to a stop light arm 12, according to an embodiment of the present invention. The billboard 10-1 may be located on a top side 14 of the stop light arm 12, as shown in FIG. 1, or, alternatively, on a bottom side 16 of the stop light arm 12. In another embodiment of the present invention, a billboard 10-2 may be located on a stop light post 18.

Referring to FIG. 2, there is shown a perspective view of a street-level billboard 10-3 attached to a walk/don't walk sign 20. With the stop light post 18 mount of FIG. 1, or the walk/don't walk sign 20 mount of FIG. 2, the billboard 10-2, 10-3 may be located at or near the eye level of a typical pedestrian.

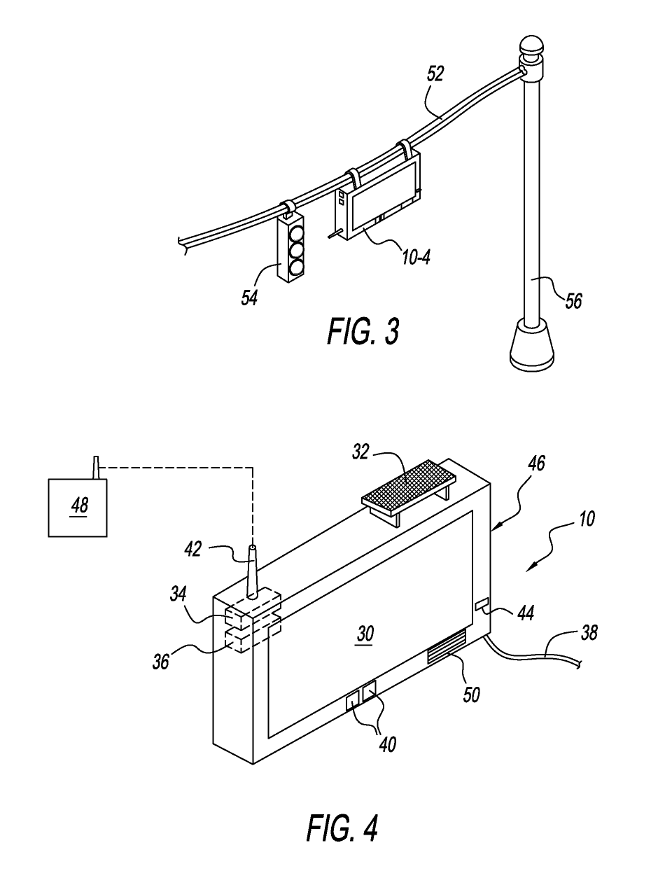

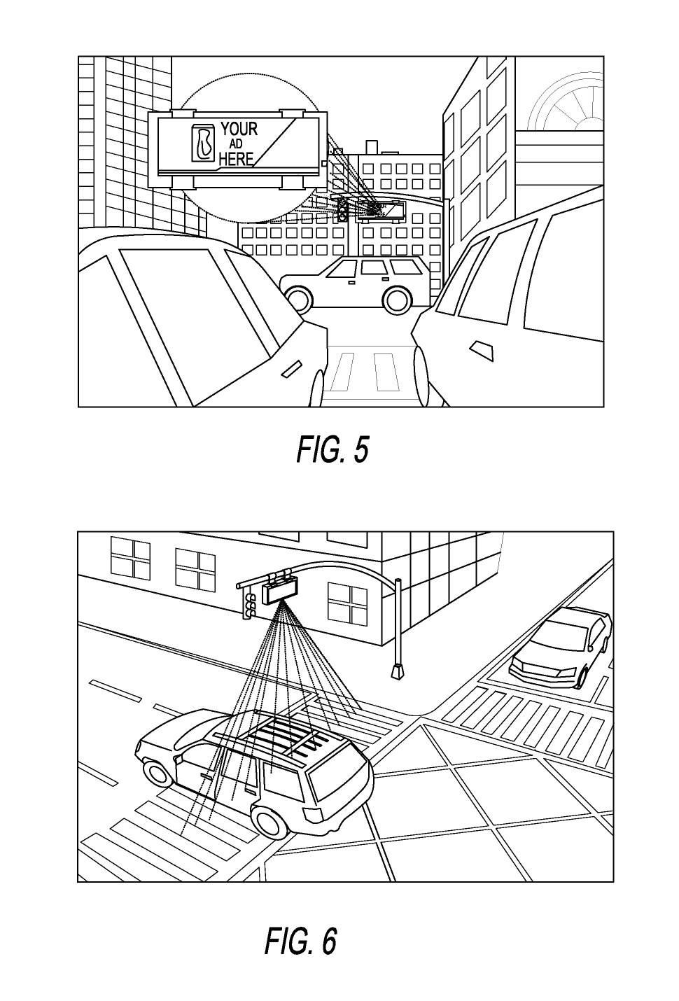

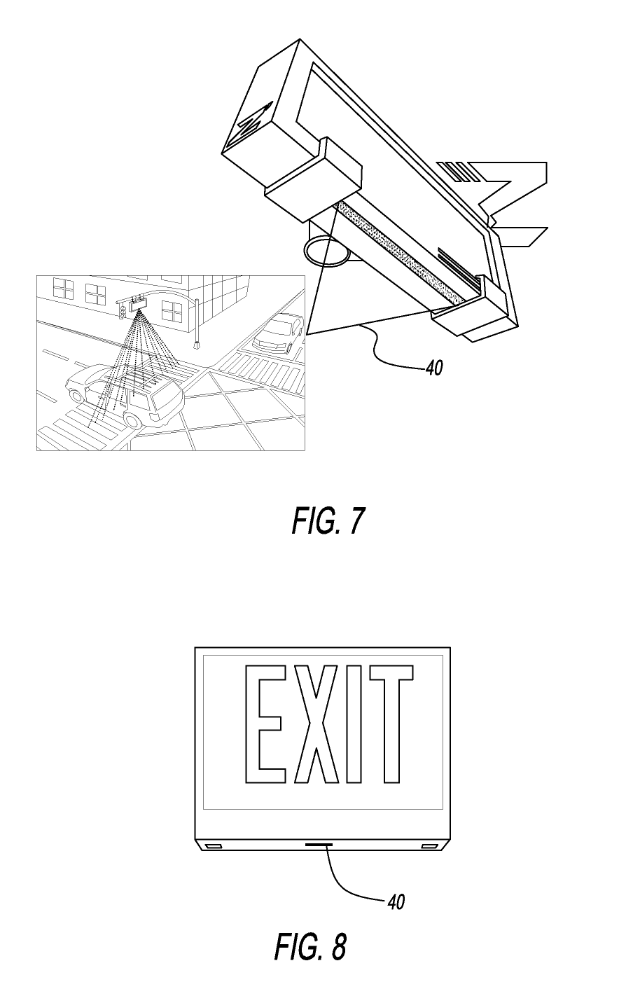

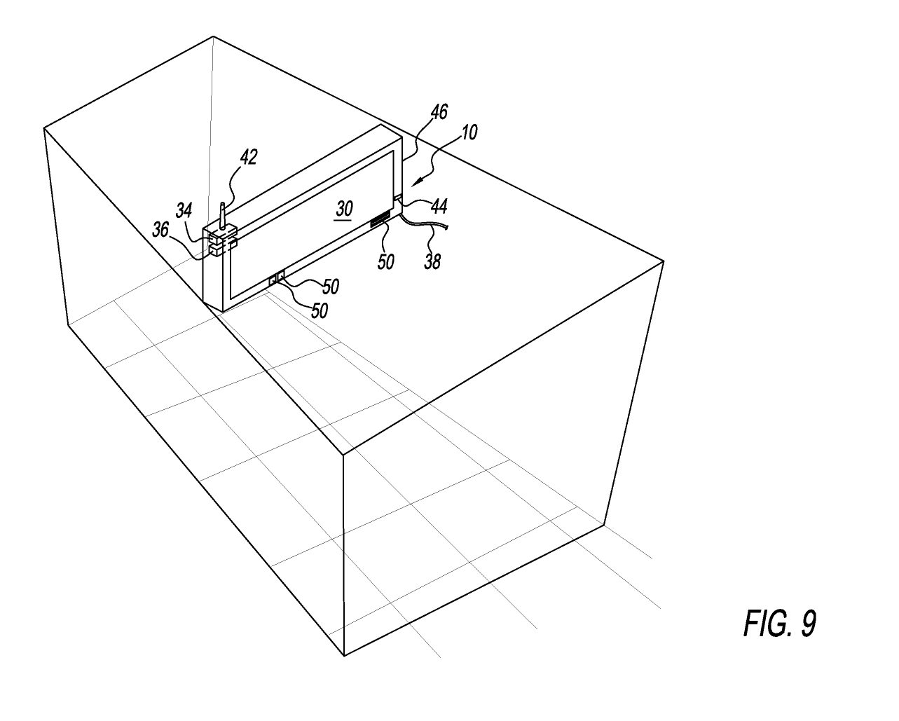

Referring to FIG. 3, there is shown a perspective view of a street-level billboard 10-4 attached to existing wires 52 that power a stop light 54. The wires 52 may run between poles 56. Power for the billboard 10-4 may be gained from the wires 52, or, as discussed below, a solar panel (FIG. 4).

Referring to FIG. 4, there is shown a detail side view of a billboard 10 that may be used as the street-level billboard 10-1, 10-2, 10-3 according to exemplary embodiments of the present invention. The billboard 10 may include an electronic display panel 30, such as a liquid crystal display (LCD) that may display an advertisement. The billboard 10 may include a conventional 3D exposure video imaging system. The billboard 10 may display in any video resolution, such as high definition, for example. The billboard 10 may also include a solar panel array 32 which may provide power to the electronic display panel 30 and other electronic components of the billboard 10. The solar panel array 32 may also provide power to the traffic lights 54, thereby reducing a city's energy consumption. The solar panel array 32, while shown in FIG. 4 as occupying a portion of the top of the billboard 10, may be sized and shaped in any manner. For example, the solar panel array 32 may be positioned above the wires 52 when the billboard 10-4 hangs as shown in FIG. 3. Alternately, the solar panel array 32 may be provided on a structure adjacent to the billboard 10. For example, the solar array panel 32 may be disposed on the top of the walk/don't walk signal 20. The billboard 10-3, similar to that shown in FIG. 2, may be disposed on the post that secures the walk/don't walk sign 20. The billboard 10 may further include a power cable 38 that may be used to provide additional power, such as AC or DC power, to the billboard 10.

The billboard 10 may include a network interface 34, such as an addressable network router, that a user may utilize to deliver programming information into a memory 36 of the billboard 10. For example, a user may access an internet address to deliver programming information to or retrieve data from the billboard 10. The network interface may include an antenna 42 for sending and receiving data. Data may also be sent to and from the billboard 10 via an external data port 44, such as a conventional USB port.

The billboard 10 may have a multiple purposes. For example, the billboard 10 may be programmed to display silver and/or amber alerts as needed by local, state and federal authorities. The billboard 10 may display emergency broadcast system messages, such as weather conditions requiring safety action, such as tornado warnings. The billboards 10 may be solely dedicated to a particular purpose (for example, amber/silver alerts) or may be used to display advertisements and show other emergency information in an as required basis.

The billboard 10 may include a global positioning system (GPS) unit included therewithin. Such a system may allow the tracking of the current locations of the billboards 10 at all times.

The billboard 10 may include one or more external sensors 40 to collect data. The sensor may collect data such as number of people or animals (such as pets) within a certain distance, such as a typical viewing distance, of the billboard, the types and/or number of vehicles passing under the billboard, the time of day, the weather, and the like. One or more of the sensors 40 may include a camera for taking photographs around the location of the billboard. The photographs may be stored in the memory 36 and sent from the billboard via the network interface 34. Photographs may be taken, for example, during playback of a advertisement as a research tool to determine whether the advertisement captures the attention of viewers and what demographic of viewers may stop to view the advertisement.

In one embodiment, the sensor 40 may collect data and the display panel 30 may alter the display based on the collected data. For example, the sensor 40 may collect weather data and the display panel 30 may display an advertisement for an umbrella when it's raining. In another embodiment, the sensor 40 may collect data concerning the types of vehicles passing under the billboard 10. In this embodiment, the display panel 30 may display an advertisement for truck repair if a relatively large number of trucks are detected. In another embodiment, the display panel 30 may display a pet product advertisement if the sensor detects a relatively large number of animals within a vicinity of the billboard 10.

In another embodiment of the present invention, the sensor 40 may collect demographic data such as the number of people within a certain distance of the billboard 10, the types of vehicles passing under the billboard, the speed of people passing under the billboard, whether people stop to view the advertisement, and the like. Advertising companies may use this collected data to determine the type of advertisements to be presented, the time of day to present certain advertisements, and the fees to charge based on the anticipated reach of the advertisement at a given time and location.

While the present invention shows the sensor 40 on the bottom of the billboard 10, the sensor 40 may be configured to sense items, people, material or the like that is behind, below, to the side or in front of the billboard 10.

The sensor 40, or one or more additional sensors, may be used for general security purposes. For example, one or more sensors may be used to detect weapons of mass destruction, such as bombs, heavy explosives, grenades, high caliber rifles, assault rifles, gun powder residue, or the like. The sensor 40 may be used to detect radiation. Police rely on counterterrorism drills to stay sharp. One exercise involves having an undercover officer with a mock device, stashed in a backpack and emitting gamma rays, slip into the subway to test the ability to detect and neutralize real radioactive threats. The sensor 40 of the present invention may be designed to detect and/or neutralize such radiation threats.

The sensors may include one or more smoke and/or fire sensors. Such sensors may use, for example, far-infrared radiation, or terahertz (THz, 1 THz=1012 Hz) radiation, to non-invasively detect biological and chemical agents, explosives and drugs/narcotics inside sealed containers; acoustic wave sensors; Geiger counters; and the like.

Other detection methods may be used for sensing various types of weapons or potential terror threats, such as explosives. For example, detection of explosives by chemiluminescence, detection of explosives by nano explosive sensors, integrated data analysis methods for explosives detection, detection of explosives by mass spectrometry, explosives detection using differential mobility spectrometry,electrochemical sensing of explosives, explosive vapor detection using microcantilever sensors, neutron techniques for detection of explosives, nuclear quadrupole resonance detection of explosives, X-ray diffraction imaging for explosives detection, detection of explosives by millimeter-wave imaging, detection of explosives by laser techniques, detection of explosives by terahertz imaging, explosives detection personnel portals, biological detection of explosives, peptide secondary structure to modulate single-walled carbon nanotube fluorescence as a chaperone sensor for nitroaromatics (PNAS, May 27, 2011, vol. 108, no. 21, pp 8544-8549, the contents of which are herein incorporated by reference), and the like.

Explosives and other chemical weapons may also be detected by a number of techniques. One exemplary technique is the external cavity quantum cascade laser (ECgcL™) by Daylight Solutions®. Another exemplary technique uses an ion mobility sensor, as developed by, for example, Applied Nanotech, Inc. Biologics may be detected by various methods known in the art. Such biologic detection may be useful for controlling the spread of disease or the outbreak of viruses.

The sensor 40 may be connected to the network interface 34 to provide an immediate notification if the sensor 40 detects an item of interest, such as a terror threat. In some embodiments, the sensor 40 may sound an alarm or release one or more doors, for example, to contain a potential terror threat within a confined area.

The billboard 10 may appear in a variety of locations. The billboard 10 may, especially when fitted with a security sensor, be deployed at bridge/tunnel entrances and/or exits, at exit signs, entrances to arenas and stadiums, mass transit stations, airports, airline jetways, airplane entrances, airline cargo/baggage streams, ship terminals, courts, hospitals, shopping centers, parking garages, schools, and the like. The billboard 10 may appear to be a digital advertisement type of billboard, thereby not alerting suspects that they are being monitored and/or scanned for potential security risks. For example, as shown in FIG. 9, the billboard 10 may be disposed in a corridor, such as a corridor at an airport or train terminal. The billboard, disposed in such a corridor, may have sensors 40 that detect items in front and/or to the sides and/or below the billboard 10.

The sensors 40 may include one or more cameras for taking photographs of either advertisement traffic or persons of interest for which a safety sensor has detected a potential threat. The camera may be able to zoom on a particular subject of interest. For safety threats, the image taken by the camera may be sent to the appropriate authorities via the network interface 34. The camera may send or stream data to a face recognition program in order to detect persons of interest from the photo and/or video data stream. For example, the face recognition program may be used to detect potential terrorists, wanted persons, or other security threats. The face recognition program may also be used to search for people missing or abducted, for example, upon the issuance of an amber or silver alert.

In some embodiments, the sensor 40 may include multiple items. For example, the sensor 40 may include a camera and an explosives detection device.

In this embodiment, if explosives are detected, the sensor 40 may take a picture of the item that triggered the explosives detector and send the picture to the proper authorities via the network interface 34.

The billboard 10 may include one or more speakers 50. The advertisements displayed on the billboard 10 may include sound to be delivered to advertisement viewers via the speakers 50. Typically, billboards 10 with speakers 50 may be placed at walk/don't walk signs, for example.

The billboard 10 may include a housing 46 for encasing the display device 30, the network interface 34, the memory 36 and other weather sensitive components. The housing 46 may be weather resistant, such as water proof. The housing 46 may also protect the components of the billboard 10 from damage due to vandalism or unintentional damage.

The billboard 10 may include a remote management station 48 for remotely controlling the advertisements displayed on the billboard 10, for receiving data collected by the sensor 40, and for interfacing with the network interface 34. The remote management station 48 may communicate via conventional wireless protocols with the billboard 10, for example, via network interface 34.

While the billboard has been described as being located at intersections, other placement locations may be considered. For example, the billboard 10 may be positioned at toll booths or parking garages to provide directed advertising to a specific market. In addition, the billboard 10 may be incorporated into a digital street sign 60. The street sign 60 may change between displaying the street name and displaying an advertisement. In this embodiment, a billboard may be similar to those described above, including elements of at least one sensor, memory, a network interface and the like. The billboard may further include a source of power, such as an electrical connection and/or at least one solar panel.

The billboard 10, when located at an intersection, for example, when adjacent to a stop light, may function, for example, only when the light is red. This design may allow advertisements to be displayed safely, without distracting drivers that may be moving through the intersection.

It should be understood, of course, that the foregoing relates to exemplary embodiments of the invention and that modifications may be made without departing from the spirit and scope of the invention as set forth in the following claims.

I claim:

1. A street-level advertisement system comprising:
an electronic display panel for displaying an advertisement;
a network interface for wirelessly sending collected data to and receiving advertisement display data from the advertisement system; and
at least one sensor for collecting external data.

2. The advertisement system of claim 1, wherein the external data includes at least one of demographic data, weather data, time of day data, and photographs.

3. The advertisement system of claim 1, wherein the external data determines the content of the advertisement displayed.

4. The advertisement system of claim 1, further comprising a memory for storing advertisements.

5. The advertisement system of claim 1, further comprising a solar panel array for providing power to the advertisement system.

6. The advertisement system of claim 5, wherein the solar panel array provides power for needs beyond the advertisement system.

7. The advertisement system of claim 1, further comprising at least one speaker for transmitting sound associated with the advertisements.

8. The advertisement system of claim 1, further comprising a central station for remotely managing the advertisements and receiving the collected data.

9. The advertisement system of claim 1, further comprising an external power cable for providing one of AC or DC power to the advertisement system.

10. The advertisement system of claim 1, wherein at least one display panel is attached to at least one of a traffic stop light arm, a traffic stop light pole, a toll booth plaza, a parking garage, and a walk/don't walk sign.

11. The advertisement system of claim 10, wherein the at least one display panel is attached to a traffic stop light arm or to a traffic stop light pole.

12. The advertisement system of claim 11, wherein the at least one display panel is activated only when a traffic stop light is red in a direction of traffic viewing the at least one display panel.

13. The advertisement system of claim 1, wherein at least one display panel is a digital street sign.

14. The advertisement system of claim 13, wherein the electronic display panel of the digital street sign that alternates between showing a street name and the advertisement.

15. The advertisement system of claim 1, wherein the electronic display panel displays the advertisement as a 3-dimensional advertisement.

16. A street-level advertisement system comprising:
a housing comprising:
an electronic display panel for displaying an advertisement;
a network interface for wirelessly sending collected data to and receiving advertisement display data from the advertisement system; and
a memory for storing advertisements;
a sensor attached to the housing for collecting external data; and
a solar panel array attached to a top portion of the housing for providing power to the advertisement system.

17. A security device comprising:
a sensor for continuously scanning an area near the security device for potential security risks;
an interface for alerting appropriate personnel of a detected security risk; and
an imaging device for capturing an image of a subject of the detected security risk.

18. The security device of claim 17, wherein the security device is integrated into a digital advertisement system.

19. The security device of claim 18, wherein the security device is deployed to scan vehicles and/or people entering a specific location.

20. The security device of claim 19, wherein the specific location is selected from the group consisting of a bridge/tunnel entrance and/or exit, an exit signs in a building, an entrance to an arena or stadium, a mass transit station, an airport, a ship terminals, a court, a business, a hospital, a shopping center, a parking garage and a school.
